(19) United States
(12) Patent Application Publication
(10) Pub. No.: US 2009/0106192 A1
(43) Pub. Date: Apr. 23, 2009

(54) Visual database for online transactions

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 09/683,599

(22) Filed: Jan. 23, 2002

Related U.S. Application Data
(60) Provisional application No. 60/267,643, filed on Feb. 9, 2001.

(51) Int. Cl. G06F 17/30

(52) U.S. Cl. 707/3; 707/E17.014

(57) ABSTRACT

A system of searching an image database. An image database is associated with an on-line merchant, and each of the images in the database are associated with items which can be purchased. Image information is entered, and that image to information is used to search the items in the database.

### CROSS REFERENCE TO RELATED APPLICATIONS

This application claims priority from provisional application No. 60/267,643 filed Feb. 9, 2001.

### BACKGROUND OF INVENTION

Customer decision support over a channel often relies on searches. For example, a customer may make purchases based on searches done on a database. Many different online merchants have multiple different products for sale. A customer can access the online merchant's site and search for the product by name or characteristics.

For example, the customers may search by the word “battery” to find all batteries. Alternatively, the customer may narrow down the search by using more terms, for example “battery for brand X” to only find batteries of the type that are made for brand X. Typically the merchants return information about the product including product specifications and a picture of the product.

This kind of searching can be carried out in many different client-server environments. For example, the large online merchants often allow the user to search in this way. The auction merchants, such as eBay, and the product comparing engines, such as “MySimon”also allows such searching.

However, a user might not know enough about an object they desire in order to fashion an educated search, especially when the product descriptions are from multiple different sources. For example, a user may want to purchase a specified item or product that has a certain look. There may be 10 or even 100 different ways of describing this product. Just as an example, a winter coat made of leather could be described as a coat, but could also be called a jacket, a parka, or many other different terms. Therefore, it may be difficult to adequately search the database, especially when the descriptions are produced by multiple sources.

### SUMMARY OF INVENTION

The present application teaches a technique of searching a database over a channel using images and/or image information. In an embodiment, the database may be a database maintained at a server for an Internet merchant such as a retail merchant or an auction merchant. A user, who is at a client computer, may enter image information as the search criteria. The image information is used to search all the images, or a subset of all the images, in the database to attempt to find items that most closely match the image.

The image searching may be used as one aspect of the search or as part of a multiple criteria search. The client can obtain an image of the item they want, e.g. from a digital camera or even a sketch. The search engine then carries out operations to find the closest match to the entered image.

### BRIEF DESCRIPTION OF DRAWINGS

These and other aspects will now be described in detail with reference to the accompanying drawings, wherein:

FIG. 1 shows a basic system which allows entry of image information to search for items to be purchased on the database associated with a server;

FIG. 2 shows a flowchart of operation of entering the image information, modifying the image information, and searching the database using the results;

FIG. 3 shows an image of an exemplary item which is difficult to describe using text words;

FIG. 4 shows a user interface for modification of and selection of parameters associated with, the image information.

### DETAILED DESCRIPTION

The present system operates by classifying and identifying images using available image detecting techniques. Such image detecting techniques fall into a number of different classes. These ways of detecting a closest match image from a plurality of images in the database are briefly described, but it should be understood that other techniques could also be used.

A first set of techniques forms a class model, usually by making a model of the desired image, and using the model as a template. The techniques of this system are described in, for example, U.S. Pat. No. 5,963,670.

Another system, described in, for example U.S. Pat. No. 5,781,899 measures differences between images. Plural pixels in the images may be compared by least squares techniques, for example, to find the closest match.

Histograms have been used to compare images. U.S. Pat. No. 6,181,817 is indicative of the histogram technique.

Formation of transforms which represent the image can also be used. The transforms have an advantage that artificial learning may be particularly useful in processing the transforms. For example, transforms may be operated using a neural net system. U.S. Pat. No. 6,041,147 describes using such transforms.

Another system searches databases of images by forming a context vector or feature vector indicative of each image, and selecting among those vectors, according to a query. Such a system is described in U.S. Pat. No. 6,173,275.

Any of these systems may be subsets of the others.

In addition, multiple ones of these systems can be combined together to form a database search engines such as described in U.S. Pat. Nos. 5,911,139; 5,835,667; 5,751,852; 5,751,286; and others.

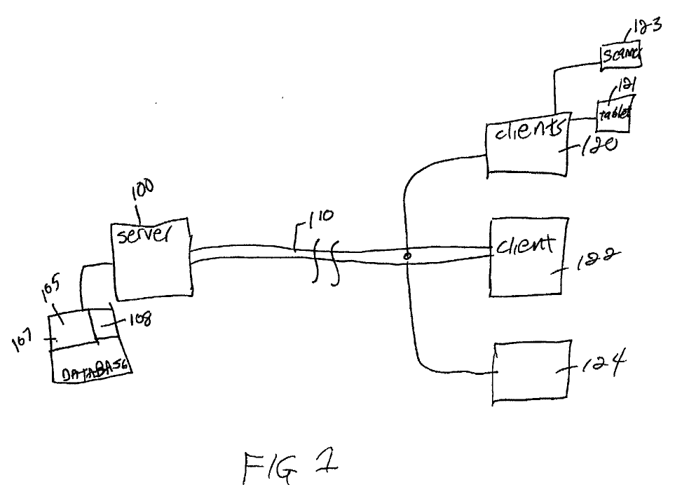

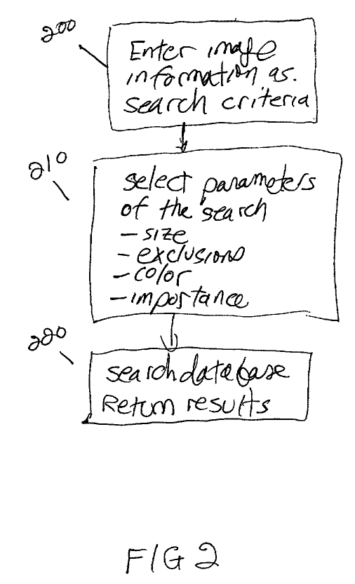

The present application therefore uses one of these existing search engine techniques to carry out a new operation, effectively allowing searching a database of information; preferably a database that customer decision support, via entry of image parts and by searching the database using these image parts. Specific technique is described with reference to FIGS. 1 and 2. FIG. 1 illustrates a typical Internet transaction via a client/server scenario. A server 106 is at a protected space and operated by an Internet merchant. The server is preferably associated with an electronic commerce site, and enables entry of purchase and/or price information for items associated with said search results. That price information may be a conventional e-commerce purchase for certain sites. The server in this example may be the eBay server for example, in which case the price information may be an amount of a bid on the item. The server may be any other server of any other type on any network. While FIG. 1 shows a single server, it should be understood that there can be multiple networked or mirrored servers, or other multiple servers which are configured in some way to accept requests.

Special advantages may be obtained in a system where multiple sellers each describe their products, such as on eBay, or in a search engine. In that case, the kinds and quantities of products which are sold may be individually described by the various sellers, with no consistent description technique being used.

The server 100 stores a database of information shown as 105. This database of information includes pictures 108 and text 107. Each item may include either only one or more pictures, only one or more text items, or both pictures and text items associated with the item. In this first embodiment, the pictures and the text items have been entered by multiple different users, e.g. users at different clients. Again, in the eBay example, any user at any client can enter any information into the database 105.

The server 100 is connected to the Internet 110, which may include a flow of information carried across any desired channel. A plurality of clients 120, 122 and 124 are shown connected to the channel 110. Any number of clients can be connected.

In this embodiment described herein, information in the database has been entered via a number of different sources, with no commonality to the information. Of course, however, this may also work when the information has been commonly entered by a single source.

This system may operate according to the flowchart of FIG. 2.

At 200, the user enters search criteria that includes image information. The image information may be an image or a part of an image. The image may be an image e.g. a scanned picture or a hand-drawn sketch, of an item the user wants to find in the database. In one embodiment, the client 120 may include a tablet shown as 121 which enables sketching pictures. A scanner such as 123 can be used to input electronic images.

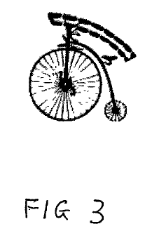

A sample of the kind of item that would be usable in this system is shown in FIG. 3. The item shown in FIG. 3 is a special kind of cycle with a large front wheel and smaller rear wheel. There is a special name for this contraption, but almost no one knows it. If one wanted to find this item on a site that sells a collection of merchandise, such as ebay, it might be very difficult to find. However, by using a graphical index entry system, closest matches to the images may be found.

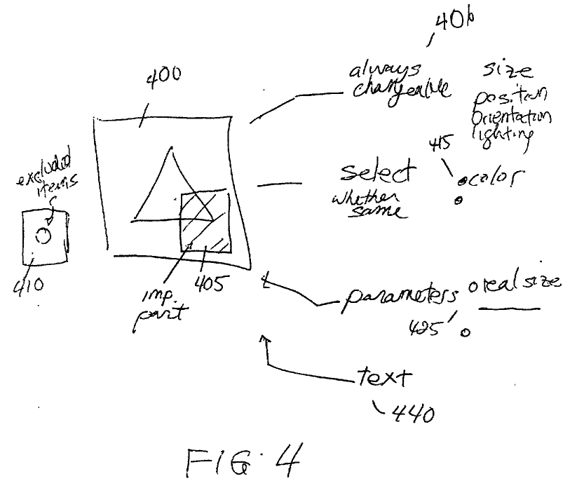

210 shows entering additional aspects associated with the image comparison, e.g., setting parameters for the search. The user interface for such a selection is shown in FIG. 4. As described above, both the image, and search text 440 may be entered. In addition, different parameters of the search may be specified. The FIG. 4 interface defines default or changeable configuration, size, position, orientation and lighting of the image information which is entered. 406 shows the image information that will be used for the search being “stretched”, reoriented, and repositioned in order to find closest matches.

FIG. 4 also allows certain colors to be selected at 415. The selection may allow returning items having similar shape but different colors.

The search may also exclude certain parts, e.g., the user may enter exclusion image information of certain elements and request that the search results exclude those certain elements. This may be equivalent to the search engine's entry of a “(−)”to indicate items which are to be excluded from the search. For example, a user may want to exclude from the search any item which has some specified feature. The searching engine will then exclude items which include that specified exclusion image information.

Parts of the image which are most important may be selected. This may be used to wait the searching, so that the search preferentially looks for those more important image items.

In the FIG. 4 user interface, the user sees the image that they are searching for as 400. The user has an opportunity to select the most important part 405. The user also has an opportunity to enter excluded items shown as 410. In this embodiment, a circle is shown as being excluded. In the user interface as shown, the user may search only for triangles which do not include circles as part of the image.

Sizing parameters may also be entered as 425; representing the real size of the device represented by the image. In the example of FIG. 3, the image may return matches not only to real size image parts, but also to miniature replicas of such real size parts. Real size parameters indicating an overall size; e.g., ranges of inches or feet, may be entered. This can allow the search to include or exclude devices of certain sizes.

Finally, once the search is complete, the server may search the database 105 using the entered information at 220. The search of the database may use any image searching technique, including those described above, including comparison using a model, comparisons between image parts, histogram comparison, formation of transforms, vectors, or any other technique.

Although only a few embodiments have been disclosed in detail above, other modifications are possible.

1. A system, comprising:
a client which allows entry of image information; and
a server, including a database associated with the server, said server connected to said client to receive said image information and using said image information to search said database associated with the server for items to be purchased which meet criteria specified in said image information and forming search results based on said image information.

2. A system as in claim 1, wherein said client allows forming forming initial image information, and subsequently setting parameters associated with said initial image information using a user interface.

3. A system as in claim 2, wherein one of said parameters associated with said image information includes exclusion information to exclude from said search results, and said server forms said search results which do not include said exclusion information.

4. A system as in claim 2, wherein one of said parameters includes a selection of a more important image portion, which is more important than other image portions, and said client forms search results which are weighted according to said more important image portion.

5. A system as in claim 2, wherein one of said parameters includes an image size, and said client forms search results which only include results having said specified image size.

6. A system as in claim 2, wherein said client includes a scanner to allow entry of said initial image information.

7. A system as in claim 2, wherein said client includes a tablet to allow entry of said initial image information.

8. A system as in claim 2, wherein one of said parameters associated with said image information includes a color, and said server operates to find items based on said color information in addition to said image information.

9. A system as in claim 1, wherein said server is associated with an electronic commerce site, and said search results include price information for items associated with said search results.

10. A method, comprising:
entering image information to a client on the network; and
sending said image information to a server on said network and using said image information to search database information on said server on said network; and
returning search results from said server to said client including price information associated with items in said search results.

11. A method as in claim 10, wherein said entering image information comprises entering an initial image, and entering parameters associated with the search of the initial image.

12. A method as in claim 10, wherein said entering image information comprises entering an initial image to be searched, and selecting a part of the initial image information which represents a more important part of the image information.

13. A method as in claim 1 0, wherein said entering image information comprises entering an initial image to be searched, and entering exclusion information to be excluded from said search.

14. A method as in claim 13, wherein said exclusion information includes image information.

15. A method as in claim 1 0, wherein said entering image information includes entering an initial image , and entering size information associated with said initial image, wherein said search results are based on said size information.

16. A method as in claim 10, further comprising displaying said image information as part of a graphical user interface, and using said graphical user interface to enter said parameters.

17. A system, comprising:
a computer, connected to a publicly available network, and including a database associated therewith, said database including image information for each of a plurality of items to be sold over said publicly available network, and price information for each of said items, said computer accepting searching image information over said publicly available network, using said image information to search said image information in said database, to return search results including items from said database which match said searching image information and price information for each of said items from said database which match said searching information.

18. A system as in claim 17, wherein said searching image information includes an image, and additional information about the searching, in addition to said image.

19. A system as in claim 1 8, wherein said additional information includes exclusion information indicative of excluded items to be excluded from said searching.

20. A system as in claim 1 8, wherein said additional information includes color information indicative of the desired colors to be included in the searching.
